(19) United States
(12) Patent Application Publication
(10) Pub. No.: US 2012/0290488 A1
(43) Pub. Date: Nov. 15, 2012

(54) REAL ESTATE PROPERTY TRANSACTION SYSTEM WITH TRANSPARENCY

(76) Inventor: Ronald L. Mazzano, Irvine, CA (US)

(21) Appl. No.: 13/460,644

(22) Filed: Apr. 30, 2012

Related U.S. Application Data
(60) Provisional application No. 61/484,623, filed on May 10, 2011.

(51) Int. Cl. G06Q 50/16

(52) U.S. Cl. 705/313

(57) ABSTRACT

A web-based technique for managing transactions related to real estate that allows transactions to be advertised and to be transparent to sellers and buyers and potential sellers and potential buyers is provided. Selling agents who represent sellers of properties list descriptions of the properties with the property transaction system. Potential buyers can then view the descriptions of the properties. When a potential buyer wants to place an offer on a listed property, the potential buyer submits the offer to a registered buying agent. After the potential buyer submits the offer to the buying agent, the buying agent posts that offer to the selling agent. Once the selling agent has accepted an offer for the property, which may be contingent on not receiving a better offer, the property transaction system then makes details of offer available to other potential buyers so the potential buyers may submit better offers.

### CROSS REFERENCE TO. RELATED APPLICATION

This application claims the benefit of U.S. Provisional Patent Application No. 61/484,623 filed May 10, 2011, which is incorporated herein by reference in its entirety.

### BACKGROUND

Currently, residential real estate properties are typically sold from a seller to a buyer who are each represented by their own real estate agents. When a seller wants to sell their house, the seller elicits the services of a selling agent who markets the house and assists in the pricing of the house and in the negotiating of a final purchase price. To market a house, the selling agent may list the house using a multiple listing service (“MLS”) that advertises the house to other real estate agents. A buyer who is interested in buying a house elicits the services of a buying agent who helps the buyer locate a house of interest and assists in the negotiating of the final purchase price. The buying agent shows the buyer the current inventory of houses that are for sale that may be of interest to the buyer. Assuming that a house of interest is currently for sale, then the buyer and the seller of the house negotiate a purchase price with the help of their agents. Upon completion of the sale, the seller may pay the selling agent a percentage of the purchase price as a commission. The selling agent may then share the commission with the buying agent.

Once a buyer makes an offer on property that is for sale, the buyer and seller typically negotiate the final purchase price and other terms privately. Because of this privacy, other potential buyers and potential sellers of comparable properties are not aware of those private terms. If a potential buyer was aware of those private terms, the potential buyer might be willing to make an even higher offer for the property. Also, if a potential seller was aware of those private terms, the potential seller might adjust the price of their property accordingly. This privacy and overall lack of transparency in selling residential real estate may result in prices and terms not reflecting what would otherwise be their true market value.

### BRIEF DESCRIPTION OF THE DRAWINGS

FIG. 1 is a block diagram that illustrates components of the property transaction system in some embodiments.

FIG. 2 is a flow diagram that illustrates the processing of an add listing component of the property transaction system in some embodiments.

FIG. 3 is a flow diagram that illustrates the processing of a receive buyer's offer component of the property transaction system in some embodiments.

FIG. 4 is a flow diagram that illustrates the processing of a register buying agent component of the property transaction system in some embodiments.

FIG. 5 is a flow diagram that illustrates the processing of a submit buyer's offer component of the property transaction system in some embodiments.

FIG. 6 is a flow diagram that illustrates the processing of a post buying agent's offer component of the transaction system in some embodiments.

FIG. 7 is a flow diagram that illustrates the processing of an accept buying agent's offer component of the property transaction system in some embodiments.

FIG. 8 is a flow diagram that illustrates the processing of a check on posted offer component of the property transaction system in some embodiments.

FIG. 9 is a flow diagram that illustrates the processing of a complete transaction component of the property transaction system in some embodiments.

### DETAILED DESCRIPTION

A real estate transaction transparency system referred to as a property transaction system is provided. In some embodiments, a web-based technique for managing transactions related to real estate allows transactions to be advertised and to be transparent to sellers and buyers and potential sellers and potential buyers. The transaction system allows potential buyers, buying agents, sellers, and so on (generally referred to as parties or users) to register via a web server of the property transaction system. Selling agents who represent sellers of properties list descriptions of the properties with the property transaction system. The description may include address, sale price, terms of sale, and so on. Potential buyers can then view the descriptions of the properties. When a potential buyer wants to place an offer on a listed property, the potential buyer submits the offer to a registered buying agent. The offer may include an offer price, timing information, various contingencies, and other terms. If the potential buyer is not currently associated with a registered buying agent, then the property transaction system may recommend a registered buying agent or may allow a buying agent who is already working with the potential buyer to register. The potential buyer may submit the offer to the buying agent via the property transaction system. After the potential buyer submits the offer to the buying agent, the buying agent reviews, may request clarification from the potential buyer, and eventually posts that offer to the selling agent, which may be via the property transaction system. The selling agent can then either accept or decline the posted offer on behalf of the seller. If the selling agent declines the offer, the selling agent may submit a counter-offer via the property transaction system. Once the selling agent has accepted an offer for the property, the property transaction system then makes the selected details of offer available to other potential buyers. For example, the selected details may include offer price, the name of the buying agent, contingencies, and so on, but might not include the name and address of the potential buyer who submitted the offer. In some embodiments, the property transaction system may allow the seller the option of selecting some or all of the details that are made available to other potential buyers. For example, the seller may not want to have details of certain contingencies made available to other potential buyers. The property transaction system may, however, require that certain details, or even all the details that may be of interest to a potential buyer, be made available to the potential buyers.

Although a selling agent accepts an offer, an accepted offer will typically have a “higher-offer” contingency for a contingency period. For example, a higher-offer contingency may be that the current offer is accepted contingent upon another offer not having been received within seven days that is at least a certain amount higher (e.g., 2% higher or some other increment) than the current offer and that other offer being otherwise acceptable to the seller. Thus, an accepted offer with a higher-offer contingency may be binding on the potential buyer and the seller subject only to the possibility of receiving a higher offer (and possibly some traditional contingencies such as an inspection). In some embodiments, the property transaction system may require that offers submitted by potential buyers include such a “higher-offer” contingency for the benefit of the sellers to make unnecessary a counter-offer by the seller adding the contingency. Because the potential buyers can view the details of the current offer, a potential buyer who would not otherwise be aware of details of the current offer may then be in a position to also place an offer on the property during the contingency period. In addition, the property transaction system allows sellers of competing properties to have access to the details of current offers so that the sellers may price and offer the competing property factoring in those details. In some embodiments, the contingency for an accepted offer may not be limited to or even include a higher offer price. For example, an offer may have a term indicating that the closing will be in 90 days. In such a case, the seller may want to include in the accepted offer, what might be referred to as a “better-offer” contingency, indicating that acceptance is contingent on another offer not having been received within 7 days with a closing in less than 45 days. Such a “better-offer” contingency may be based on various combinations of terms for which the seller would consider another offer to be better.

The property transaction system may also be used to help verify that the sale of property has been conducted in a reasonable manner by the parties involved. A sale might not be reasonable, for example, if unbeknownst to the seller the buyer is somehow affiliated with the selling agent (e.g., the buyer is a relative of the selling agent or the selling agent is a shareholder in the corporation that is the buyer). The transparency of transactions conducted using the property transaction system will help to ensure that sales have been conducted in a reasonable manner. For example, if an offer was from a potential buyer who was affiliated with the selling agent, the advertising of that offer to other potential buyers would allow potential buyers not affiliated with the selling agent to make a higher offer. Moreover, the property transaction system may provide a “certification” or a “certified transaction history” for a sale that includes the original listing, changes to the listing, offers, counter-offers, communications made between the parties, and any other activity that was conducted through the property transaction system. A seller may use such a certification to help verify that the sale was conducted in a reasonable manner (e.g., non-fraudulently).

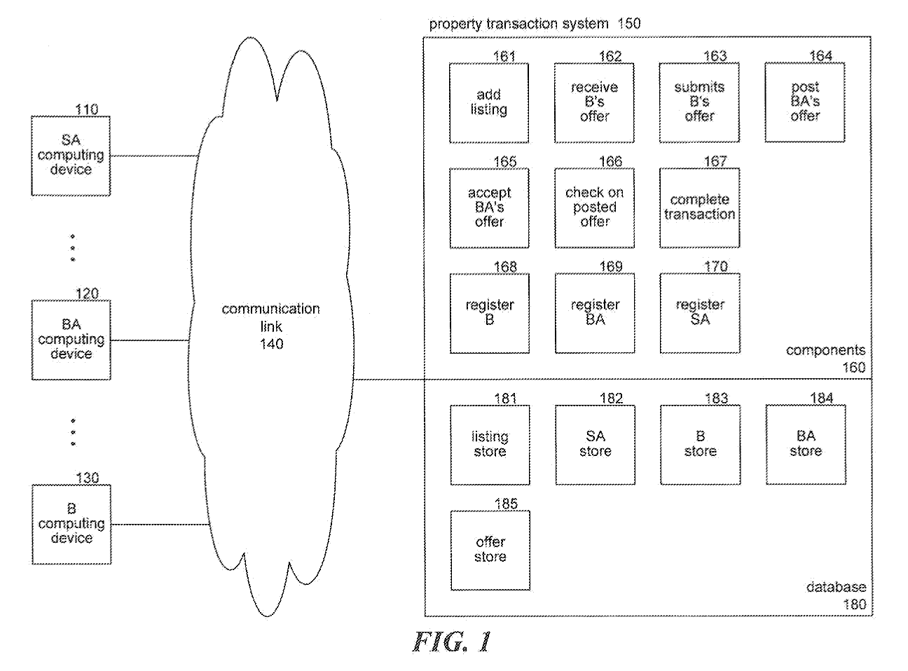

FIG. 1 is a block diagram that illustrates components of the property transaction system in some embodiments. The property transaction system 150 is connected via a communications link 140 (e.g., Internet) to selling agent computing devices 110, buying agent computing devices 120, and buyer computing devices 130. The computing devices may access the property system via a web browser. The property transaction system includes various components 160 and a database 180. The components include an add listing component 161, a receive buyers offer component 162, a submit buyers offer component 163, a post buying agent's offer component 164, an accept buying agent's offer component 165, a check on posted offer component 166, a complete transaction component 167, a register buyer component 168, a registered buying agent component 169, and a register selling agent component 170. Although not shown, the property transaction component may also include a communication component and a certification component. The communication component may provide an secure electronic communication system (e.g., electronic mail or instant messages) for use by the parties to a sale transaction. The certification component generates the certification for a transaction as described above. The database includes a listing store 181, a selling agent store 182, the buyer store 183, a buying agent store, 184, and an offer store 185. In addition, the property transaction system may include a communications store and a history store. The listing store contains an entry for each property that has been listed and includes description and other details of the property such as minimum offer price, terms of sale, seller, selling agent, and so on. The selling agent store contains an entry for each registered selling agent that provides information on the selling agent. The buyer store contains an entry for each registered buyer that provides information on the buyer. The buying agent store contains an entry for each registered buying agent that contains information on the buying agent. The offer store may have an entry for each offer that has been submitted for each property in the listing store. The entry for each offer may indicate the status such as submitted, posted, accepted, declined, and so on. Thus, the offer store contains a complete history of the offers that have been submitted for each listed property. The communications store may include a history of electronic communications of the property transaction system, and the history store may contain a complete history for each listing including a history of changes to the listings, offers, selling agents, buyers, buying agents, accesses to the listings (and by whom), comparable listings, and so on. Each of these stores may be divided in multiple stores, and various stores may be combined into a single store.

The computing device on which the property transaction system is implemented may include a central processing unit, memory, input devices (e.g., keyboard and pointing devices), output devices (e.g., display devices), and storage devices (e.g., disk drives). The memory and storage devices are computer-readable media that may contain instructions that implement the property transaction system. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on. The property transaction system may be accessed from any device that can access the internet including tablets, desktop computers, personal digital assistants, laptops, cell phones, smart phones, set-top-boxes, and so on. The property transaction system may also provide applications, plug-ins, or other client-side software that executes on these devices to facilitate access of the property transaction system.

The property transaction system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

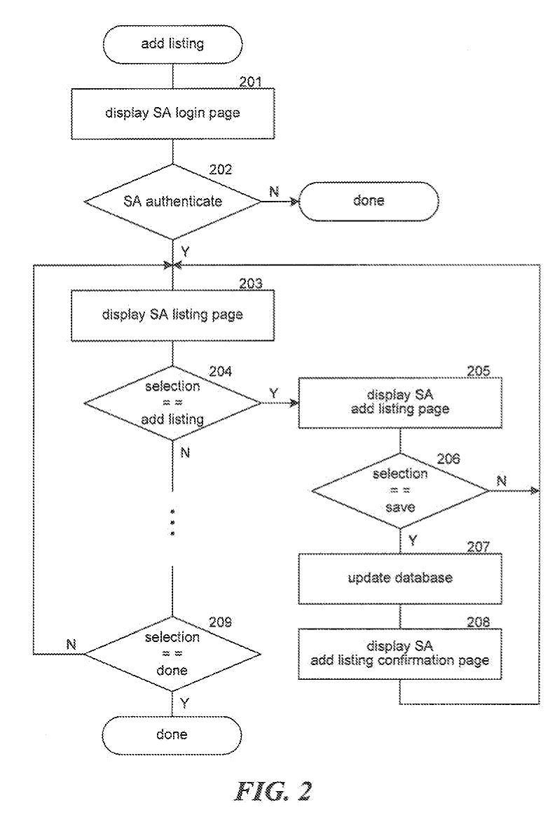

FIG. 2 is a flow diagram that illustrates the processing of an add listing component of the property transaction system in some embodiments. The component allows a registered selling agent to add a new listing to the database. In block 201, the component displays a selling agent login page. In decision block 202, if the selling agent is registered and can be authenticated, then the component continues at block 203, else the component completes. In block 203, the component displays selling agent information and listing pages to provide general information on the property transaction system and allow the selling agents to view their listings. In decision block 204, if the selling agent indicates to add a listing, then the component continues at block 205, else the component continues at block 209 after processing any additional selection as indicated by ellipsis. In block 205, the component displays the selling agent listing display page. In decision block 206, if the selling agent indicates to add the listing, then the component continues at block 207, else the component loops to block 203. In block 207, the component updates the database to indicate the new listing. In block 208, the component displays a confirmation page with the added listing and then loops to block 203. In decision block 209, if the selling agent selects a done indication, then the component completes, else the component loops to block 203.

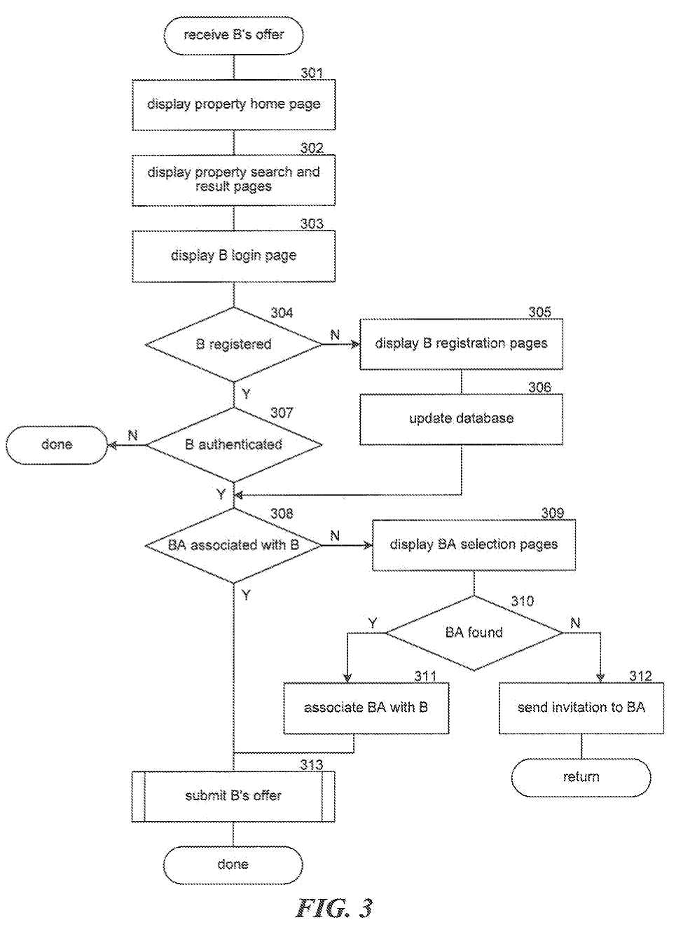

FIG. 3 is a flow diagram that illustrates the processing of a receive buyer's offer component of the property transaction system in some embodiments. The component controls the registering of a buyer and associating of the buyer with a buying agent as appropriate, and then submits an offer. In block 301, the component displays the home display page for the property transaction system. In block 302, the component displays property search and result pages to allow a potential buyer to review the listed properties. In block 303, the component displays a login display page. In decision block 304, if the buyer is registered, then the component continues at block 307, else the component continues at block 305. In block 305, the component displays registration pages to the potential buyer. In block 306, the component updates the database to reflect that the potential buyer is registered. In decision block 307, if the registered buyer can be authenticated, then the component continues at block 308, else the component completes. In decision block 308, if a buying agent is already associated with the buyer as indicated by the database, the component continues at block 313, else the component continues at block 309. In block 309, the component displays a buying agent selection page. In decision block 310, if the buying agent is registered, then the component continues at block 311, else the component continues at block 312. In decision block 311, the component, associates a buying agent with the buyer and updates the database. In decision block 312, the component displays a display page and then sends an invitation to the buying agent to register and then completes. In block 313, the component invokes the submit buyer's offer component to allow the buyer who is registered and is associated with a buying agent to submit an offer. The component then completes.

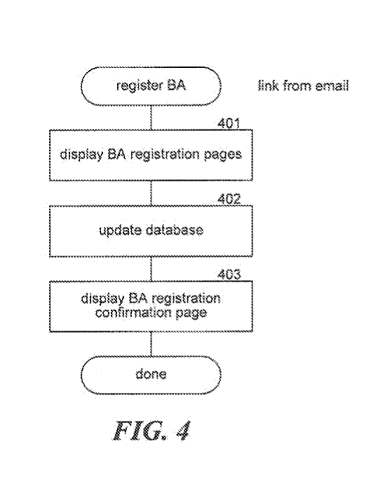

FIG. 4 is a flow diagram that illustrates the processing of a register buying agent component of the property transaction system in some embodiments. The client agent may be notified via an electronic mail message that a buyer would like the buying agent to register. The buying agent can then select a link from that electronic mail message to display pages for registering. In block 401, the component displays registration display pages for a buying agent's registration. In block 402, the component updates the database to indicate that the buying agent is registered. In block 403, the component displays a registration confirmation page and then the component completes.

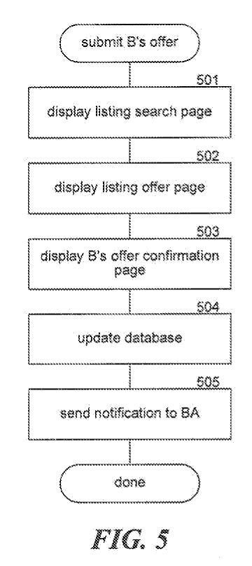

FIG. 5 is a flow diagram that illustrates the processing of a submit buyer's offer component of the property transaction system in some embodiments. In block 501, the component displays a listing search and result page. In block 502, the component displays a listing offer page through which the potential buyer can submit an offer. In block 503, the component displays a confirmation display page to indicate that the offer has been submitted. In block 504, the component updates the database to reflect the submitted offer. In block 505, component sends a notification of the offer to be potential buyer's buying agent and then completes.

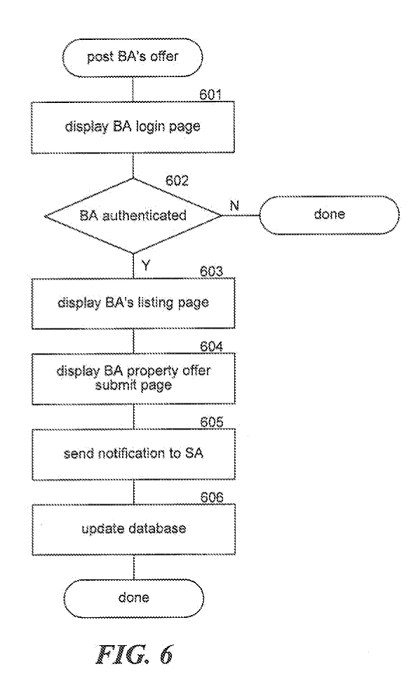

FIG. 6 is a flow diagram that illustrates the processing of a post buying agent's offer component of the transaction system in some embodiments. In block 601, the component displays a buying agent's login display page. In decision block 602, if the buying agent is registered and can be authenticated, then the component continues at block 603, else the component completes. In block 603, the component displays a listing display page that lists the offers made by potential buyers associated with the buying agent that have been submitted and/or posted. In block 604, the component displays a submit offer display page to allow the buying agent to post an offer to the selling agent. In block 605, the component sends a notification to the selling agent. In block 606, the component updates the database to indicate that the offer has been posted to the selling agent and completes.

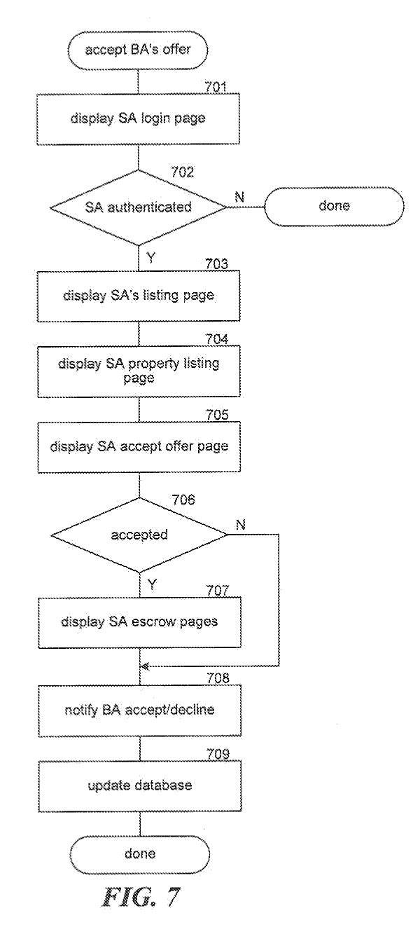

FIG. 7 is a flow diagram that illustrates the processing of an accept buying agent's offer component of the property transaction system in some embodiments. In block 701, the component displays a login display page for the selling agent. In decision block 702, if the selling agent is registered and can be authenticated, then the component continues at block 703, else the component completes. In block 703, the component displays a listing display page for the selling agent. In block 704, the component displays a property a selling agent listing display page to indicate the properties listed by the selling agent. In block 705, the component displays accept offer display page so that the selling agent can accept or decline an offer. In decision block 706, if the selling agent accepts the offer, then the component continues at block 707, else the component continues at block 708. In block 707, the component displays various escrow display pages to allow the selling agent to provide escrow information for the accepted offer. In block 708, the component notifies the buying agent whether the selling agent has accepted or declined the submitted offer. In block 709 the component updates the database to indicate whether the offer has been accepted or declined and then completes.

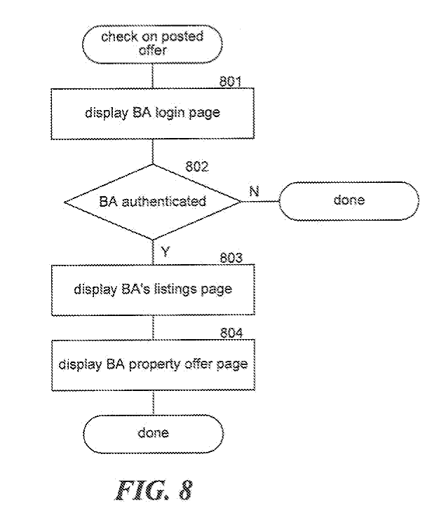

FIG. 8 is a flow diagram that illustrates the processing of a check on posted offer component of the property transaction system in some embodiments. In block 801, the component displays a buying agent login display page. In decision block 802, if the buying agent is registered and can be authenticated, then the component continues at block 803, else the component completes. In block 803, the component displays a listing page for the buying agent. In block 804, the component displays an offer page for the buying agent and then completes.

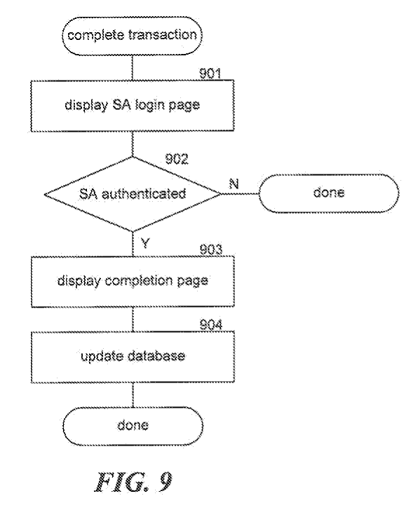

FIG. 9 is a flow diagram that illustrates the processing of a complete transaction component of the property transaction system in some embodiments. In block 901, the component displays a login display page for the selling agent. In decision block 902, if the selling agent is registered and can be authenticated, then the component continues at block 903, else the component completes. In block 903, the component displays completion pages to indicate that the sale of the property has been completed. In block 904, the component updates the database to indicate the completion and then completes

From the foregoing, it will be appreciated that specific embodiments of the property transaction system have been described herein for purposes of illustration, but that various modifications may be made without deviating from the spirit and scope of the invention. Accordingly, the invention is not limited except as by the appended claims.

I/We claim:

1. A web-based method for managing transactions in real estate, the method comprising:
receiving at the web server from a selling agent a description of property that is being offered for sale by a seller;
displaying to potential buyers the description of the property along with an indication of a current offer for the property, the current offer being contingent on the seller not receiving a better offer within a contingency period;
receiving at the web server during the current contingency period a submission from a potential buyer of a new offer for the property;
receiving at the web server from a buying agent of the potential buyer a posting of the new offer for the property; and
receiving at the web server an acceptance from the selling agent of the posted offer such that the accepted new offer becomes a new current offer with a new current contingency period.

2. The method of claim 1 including maintaining a history of activity relating to the property that is being offered for sale.

3. The method of claim 2 including generating a certified transaction history from the maintained history.

4. The method of claim 1 including when the potential buyer is not represented by a buying agent, recommending a buying agent to the potential buyer.

5. The method of claim 1 wherein the selling agent, the buying agent, and the potential buyer are registered with the web server.

6. The method of claim 1 wherein the better offer includes a higher offer price.

7. The method of claim 1 wherein the posted offer includes an indication that the potential buyer agrees to a better offer contingency.

8. The method of claim 1 wherein the displayed indication of the current offer includes offer price and an indication of contingencies of the current offer.

9. The method of claim 1 wherein the displayed indication of the current offer includes terms of the current offer as selected by the selling agent.

10. A system for managing transactions in real estate, comprising:
a listing store storing listings of properties that are for sale;
an offer store storing offers that have been submitted for the properties that are for sale;
a storage device storing computer-executable instructions that control the system to perform a method comprising:
receiving from a selling agent a description of property that is being offered for sale by a seller;
storing in the listing store a listing for the property;
sending to potential buyers information about the property and a current offer derived from the listing store and the offer store, the current offer having a contingency such that the seller can accept another offer that satisfies the contingency, the contingency having a contingency period;
receiving from a buying agent of a potential buyer a posting of a new offer for the property that satisfies the contingency; and
receiving an acceptance from the selling agent of the posted offer such that the accepted new offer becomes a new current offer; and
a processor for executing the computer-executable instructions stored in the data storage device.

11. The system of claim 10 wherein the computer-executable instructions further control the system to provide a certified transaction history for the property.

12. The system of claim 10 wherein the contingency is based on another offer having an offer price that is greater than a minimum offer price that is derived from an offer price of the current offer.

13. The system of claim 12 wherein the minimum offer price is a certain percentage greater than the offer price of the current offer.

14. The system of claim 10 wherein the contingency is based on the other offer not including a certain term of the current offer.

15. The system of claim 10 wherein the computer-executable instruction further controls the system to recommend agents to potential buyers and potential sellers.

16. A computer-readable storage device storing computer-executable instructions that control a computing system to perform a method comprising:
receiving from a selling agent a description of property that is being offered for sale by a seller;
sending to potential buyers information about the property and a current offer that has been accepted by the seller, the current offer having a contingency such that the seller can accept another offer that satisfies the contingency during a contingency period;
receiving from a buying agent of a potential buyer a posting of a new offer for the property that satisfies the contingency; and
during the contingency period, receiving an acceptance from the selling agent of the posted offer such that the accepted new offer becomes a new current offer.

17. The computer-readable storage device of claim 16 wherein the computer-executable instructions further control the computing system to provide a certified transaction history for the property.

18. The computer-readable storage device of claim 16 wherein the contingency is based on another offer having an offer price that is greater than a minimum offer price that is derived from an offer price of the current offer.

19. The computer-readable storage device of claim 16 wherein the minimum offer price is a certain percentage greater than the offer price of the current offer.

20. The computer-readable storage device of claim 16 wherein the contingency is based on the other offer not including a certain term of the current offer.
